(19) United States
(12) Patent Application Publication
(10) Pub. No.: US 2025/0360710 A1
(43) Pub. Date: Nov. 27, 2025

(54) ELECTROHYDRODYNAMIC PRINT HEAD WITH DISTRIBUTED FEED STRUCTURE

(71) Applicant: Scrona AG, Zürich (CH)

(72) Inventor: Patrick GALLIKER, Richterswil (CH)

(73) Assignee: Scrona AG, Zürich (CH)

(21) Appl. No.: 18/996,142

(22) PCT Filed: Aug. 11, 2022
(86) PCT No.: PCT/EP2022/072592

§ 371 Date: Jan. 17, 2025

(51) Int. Cl. B41J 2/06; B41J 2/145

(52) U.S. Cl. CPC B41J 2/06; B41J 2/145; B41J 2202/02; B41J 2202/12

(57) ABSTRACT

The electrohydrodynamic print head includes ink nozzles as well as blow openings for dry gas and suction openings at its front side. In addition, humid gas is fed through the print head to the nozzles. The front side has an elongate active region surrounded by a passive region, with all the ink nozzles being arranged in the active region. The blow and suction openings are arranged in the active and the passive regions such that the active region is surrounded by ventilation openings. Ink feed slit vias beneath the rows of the nozzles provide a homogenous ink supply. In one of the bottom layers of the print head, bulk feed and withdrawal ducts distribute the fluids to smaller ducts above them. Manifolds are provided in the print head in order to homogenize the feed and withdrawal of the fluids. Manifolds are used to further homogenize with fluid flows.

### TECHNICAL FIELD

The invention relates to an electrohydrodynamic print head and to a printing system comprising such a print head.

### BACKGROUND ART

It has been known to provide an electrohydrodynamic inkjet printing system with a print head having a plurality of ventilation ducts located at the ink nozzles. The ventilation ducts are used to feed dry gas to the space between the print head and the target, thereby expediting a uniform drying of the ink on the target. The feed structure for the fluids in such print heads can become fairly complex. In particular, it can be a challenge to maintain a homogeneous flow of gas and ink over the whole print head.

### DISCLOSURE OF THE INVENTION

An object of the present invention is to provide a print head with a good homogeneity of the flows of gas and ink.

This problem is solved by the print head of claim 1. Hence, the print head comprises at least the following elements:
A plurality of ink nozzles at a front side of the print head: The nozzles are adapted to eject ink from the print head by means of electrical fields. Typically, each nozzle comprises an ink retainer to provide ink at a defined location and an ejection electrode to eject ink from the ink retainer.
A plurality of ventilation openings at the front side of the print head: The ventilation openings are used to feed dry gas to the space between the print head and the target and/or to carry of gas from this space.
At least one ink feed terminal: This opening is adapted to feed ink from an ink source to the print head.
Ink feed ducts connecting the ink feed terminal to the nozzles: The ink feed ducts are adapted to guide the ink from the ink feed terminal to the nozzles.

The front side has an active region surrounded by a passive region. All the ink nozzles are arranged in the active region while the ventilation openings are arranged in the active and the passive regions such that the active region is surrounded by ventilation openings.

This design allows to maintain a more homogenous gas flow at the edge of the active region.

In the active region, the nozzles may be arranged in rows and columns, in particular with the rows and columns extending perpendicularly to each other.

Advantageously, the active region is elongate and has a short axis and a long axis. The columns of the nozzles extend along the long axis and rows of the nozzles extend along the short axis. Such a design allows to laterally feed fluid to/from the active region along the rows using comparatively short ducts, thereby reducing the flow resistance and improving flow homogeneity.

The ink feed ducts may comprise a plurality of ink feed slit vias and at least one horizontal bulk ink feed duct. Each ink feed slit via has a backward end connected to the bulk ink feed duct and a forward end connected to several nozzles arranged in a row. The ink feed slit vias are arranged parallel to the rows of the ink nozzles, e.g. behind the rows of the nozzles. This design again improves the homogeneity of the ink flow to the nozzles.

The print head may further comprise at least one ink withdrawal terminal and ink withdrawal ducts connecting the nozzles to the ink withdrawal terminal. This allows to establish a circulation of ink through the ink head.

The ink withdrawal ducts may comprise at least one bulk ink withdrawal duct extending horizontally along a first longitudinal edge of the active region in order to withdraw ink from along said edge. Advantageously, there are two such bulk ink withdrawal ducts on the opposite longitudinal edges of the active area, in particular on opposite sides of the ink feed slits mentioned above.

The ink withdrawal duct may further comprise an ink withdrawal manifold extending horizontally and arranged at a level above the bulk ink withdrawal duct and a plurality of withdrawal vias extending in parallel between the ink withdrawal manifold and the bulk ink withdrawal duct. Such a manifold provides a good flow and pressure distribution over the print head.

The print head may further comprise at least one humid gas feed terminal and humid gas feed ducts connecting humid gas feed terminal to the nozzles. The terminal(s) and ducts are suited to carry a humid gas, i.e. a gas with a high saturation of liquid, to the nozzles in order to reduce ink evaporation at the nozzles. Advantageously, this embodiment of the print head is used in a printing system having a humid gas source with an evaporator connected to the humid gas feed terminal.

In order to evenly distribute fluid supply or withdrawal, the print head my further comprise a manifold structure arranged at a level of the print head located in front of most parts of the nozzles and continually extending over active area of the print head. At the level of the manifold structure and at each nozzle, a closed-loop wall (i.e. a wall forming a closed loop separating the interior of the loop from the exterior) separates the manifold structure from a passage that provides a path from one nozzle to a nozzle opening at the front side of the print head.

In yet further advantageous design, the print head may comprise a folded path design for feeding or withdrawing gas to/from the front side: In this case, it comprises gas ducts connecting openings in the back side of the print head and openings in the front side of the print head. The gas ducts comprise a first section extending into a forward direction and a second section extending into a backward direction of the print head.

The print head may further comprise at least one of the following elements:
At least one dry gas feed terminal and dry gas feed ducts connecting humid gas feed terminal to blow openings at the front side of the print head. This allows to provide drying gas (which is a gas drying than the humid gas mentioned above) to the space between the print head and the target. In this case, the print head advantageously forms part of a printing system with a dry gas source connected to the dry gas feed terminal(s).
At least one gas withdrawal terminal and gas withdrawal feed ducts connecting gas withdrawal terminal and suction openings at the front side of the print head. This allows to withdraw gas from the space between the print head and the target, thereby removing evaporated solvent from the substrate quicker and assist the drying speed. In this case, the print head advantageously forms part of a printing system with a gas sink connected to the gas sink terminal(s).

The invention also relates to a printing system comprising such a print head and an ink source connected to the at least one ink feed terminal of the print head. It further comprises at least one of the following elements:
An ink source connected to the at least one ink feed terminal of the print head.
An ink sink connected to at least one ink withdrawal terminal of the print head.
A dry gas source connected to at least one dry gas feed terminal of the print head.
A gas sink connected to at least one gas withdrawal terminal of the print head.
A humid gas source connected to at least one humid gas feed terminal of the print head.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a part-sectional view of a print head,

FIG. 2 is a view of the print head from the front side,

FIG. 3 is a sectional view of the backmost layer S1 of the print head,

FIG. 4 is a section view of layer S2,

FIG. 5 illustrates the arrangement of the vias in layer S3 in relation to the structures in the layers A1-A3 above it,

FIG. 6 is a vertical sectional view of the print head along line VI-VI of FIG. 7,

FIG. 7 is a horizontal sectional view through layer S3,

FIG. 8 is a view of the structures in layers A1-A3 as seen from below with the layers S1-S3 not rendered,

FIG. 9 is a horizontal sectional view through layer A1,

FIG. 10 is a horizontal sectional view through layer A2,

FIG. 11 is a horizontal sectional view through layer A3 with one nozzle area enlarged,

FIG. 12 is a horizontal sectional view through layer M01 with one nozzle area enlarged,

FIG. 13 is a horizontal sectional view through layer M02 with one nozzle v enlarged,

FIG. 14 is a horizontal sectional view through layer M03 with one nozzle area enlarged,

FIG. 15 is a horizontal sectional view through layer M04 with one nozzle area enlarged,

FIG. 16 is a horizontal sectional view through layer M05 with one nozzle area enlarged,

FIG. 17 is a horizontal sectional view through layer M07 with one nozzle area enlarged,

FIG. 18 is a horizontal sectional view through layer M08,

FIG. 19 is a view of the structures in layers M04-M07 (in this figure, the only thing of layer M08 that is shown are the front contours of its openings),

FIG. 20 is a vertical sectional view through the active region of the print head along line XX-XX of FIG. 19,

FIG. 21 is a vertical sectional view through the active region of the print head along line XXI-XXI of FIG. 19,

FIG. 22 is a vertical sectional view through the active region of the print head along line XXII-XXII of FIG. 19,

FIG. 23 is a vertical sectional view through the active region of the print head along line XXIII-XXIII of FIG. 19,

FIG. 24 is a vertical sectional view through the passive region of the print head along line XXIV-XXIV of FIG. 19,

FIG. 25 is a superposition of layers M03 (hatched) and M04 (black), and

FIG. 26 is a block diagram of a printing system.

### MODES FOR CARRYING OUT THE INVENTION

### Definitions

“Forward” or “front” defines the direction into which the print head is designed to eject ink.

“Backward” or “behind” defines the opposite direction to the forward direction.

“At the front” and “at the back” are understood to designate a location at levels forward from or backward from something else.

“Front” and “back” are the forward and backward sides.

The ejection direction of the print head defines the “vertical” upwards direction, i.e. the print head is, by definition, designed to eject ink upwards. (In operation, it may, of course, be under any angle to the direction of gravity.) Hence, definitions such as “above” and “below” are to be understood in reference to this definition of “vertical”.

“Horizontal” is any direction perpendicular to the vertical direction.

“Lateral” designates something that is offset horizontally to something else.

A “via” is a fluid duct that is adapted to feed, in operation, a fluid vertically through one or more layers of the print head.

A “horizontal” duct is a fluid duct that is adapted to convey, in operation, a fluid horizontally along one or more layers of the print head, i.e. it designates a duct having a longitudinal axis extending parallel to front and back surfaces of the print head.

A “manifold” is a duct interconnecting several input ducts and, at the same time, connecting them to several output ducts.

### Overview

The overall design of an exemplary embodiment of the print head is best described in reference to FIGS. 1-3.

The print head has a front side 10 and a back side 12. In operation, front side 10 oriented towards the target to be printed upon while back side 12 faces away therefrom.

A plurality of nozzle openings 14 as well as a plurality of ventilation openings, the latter including blow openings 16 and suction openings 18, are arranged on front side 10.

An ink nozzle 50, as described in more detail below, is arranged at each nozzle opening 14. The print head is adapted to eject, in operation, ink through the nozzle openings 14. In addition, it may blow gas through the nozzle openings 14. Further, gas is blown through the blow openings 16 and withdrawn through the suction openings 18.

The gas blown through the nozzle openings 14 has higher humidity (“humid gas”) than the gas blown through the blow openings 16 (“dry gas”). In this context “humidity” designates the amount of liquid dissolved in the gas. Advantageously, the liquid is the same as the one that the dye particles or molecules of the ink are suspended or dissolved in. Blowing humid gas through the nozzle openings 14 reduces the evaporation of ink solvent at the nozzles, thereby reducing the ink's tendency to form dry deposits at the nozzles 50. Blowing dry gas through the blow openings supports the ink drying process at the target. Withdrawing gas through the suction openings 18 allows to maintain a dry atmosphere between the print head and the target and to avoid condensation of evaporated liquid at the printhead surface, in case that the printhead surface cooled down below the temperature of the substrate. The periodic arrangement of the suction and blow holes makes it possible to achieve a most uniform flow pattern for each nozzle and the alternating arrangement of suction and blow holes shown in FIG. 1 reduces lateral air flow at the main nozzle axis, i.e. the designated flight direction of ejected droplets.

Advantageously, the print head is adapted to withdraw the same volume flow of gas through the suction openings 18 as the combined volume flow of gas blown through the nozzle openings 14 and the blow openings 16.

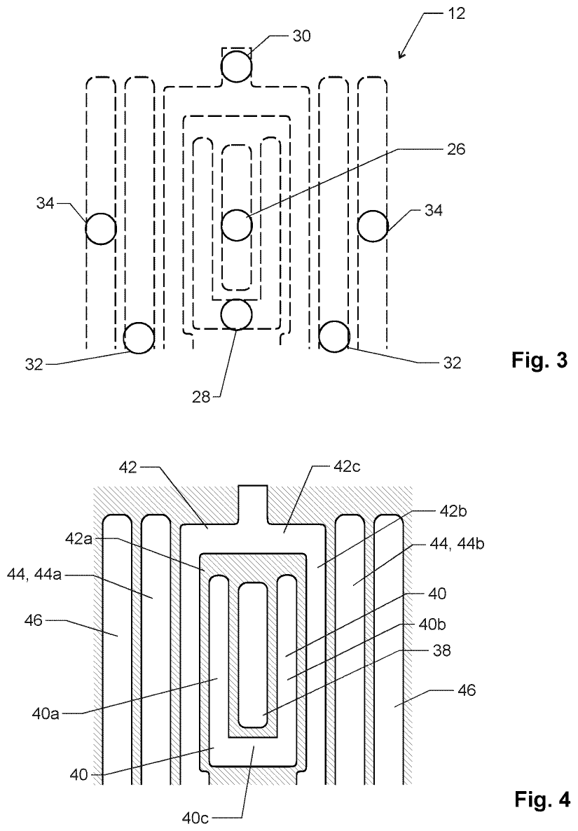

The blow and suction openings 16, 18 are advantageously arranged alternatingly as described in WO 2021/008817 in reference to FIG. 3 therein.

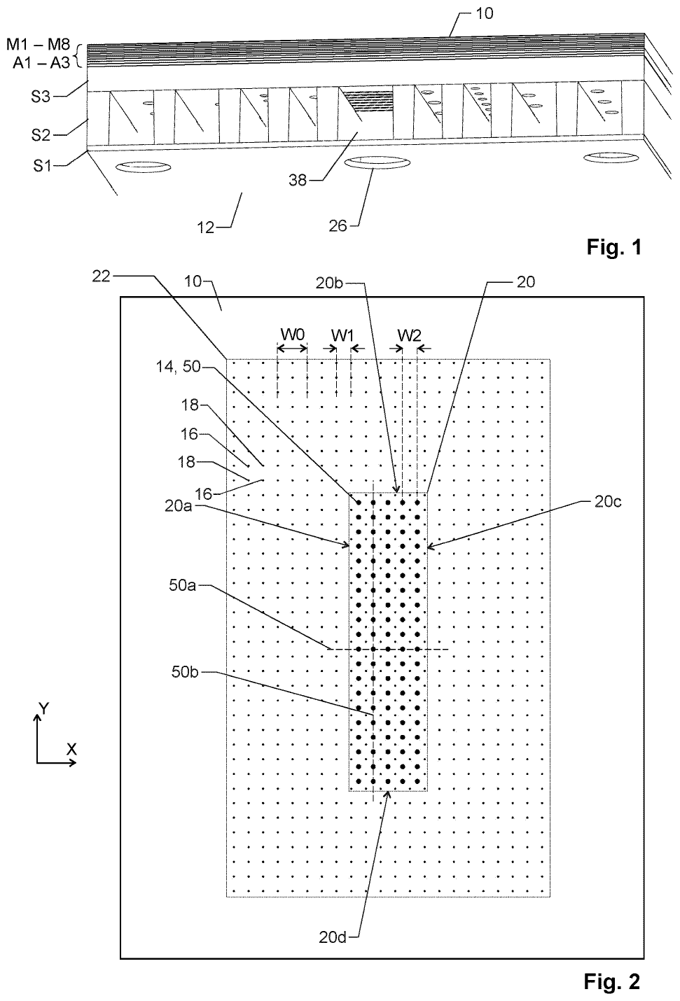

As shown in FIG. 2, the nozzle openings 14 are arranged in an active region 20 of the print head, which is laterally, on all sides, surrounded by a passive region 22 without nozzle openings 14. The blow openings 16 and the suction openings 18 are arranged in both the active region 20 as well as the passive region 22.

Advantageously, the blow openings 16 and the suction openings 18 are each spaced regularly, at a spacing W0. The spacing W1 between neighboring suction and blow openings is equal to W0/2. The spacing W2 between neighboring nozzle openings 14 is also equal to W0/2.

The horizontal width of passive region 22 along each edge of active region 20 is advantageously at least two times, in particular at least three times, the spacing W0 between adjacent blow openings 16, which results in a more homogeneous flow pattern in active region 20.

Advantageously, in operation of the print head, the distance between the print head and the target is smaller than said horizontal width of the passive region 22.

Active region 20 has, in particular, at least three rows 50a and at least three columns 50b of nozzle openings. However, the present concept can also be advantageously used for an active region 20 having a single column 50b of nozzle openings only.

In a preferred embodiment, active region 20 is elongate having a short horizontal axis X parallel to its traversal edges 20b, 20d and a long horizontal axis Y parallel to its longitudinal edges 20b, 20d, with the columns 50b of the nozzles 50 and the nozzle openings 14 extending along the long axis Y and the rows 50a extending along the short axis X of active region 20. In this case, there are more nozzles 50 and nozzle openings 14 on each column 50b than on each row 50a, in particular there are at least twice as many nozzles 50 and nozzle openings 14 on each column 50b than on each row 50a. As will become apparent below, such an arrangement makes it easier to provide a large number of nozzles while maintaining a homogeneous pattern of the gas and ink flow.

FIG. 3 shows the macroscopic interface openings at back side 12 of the print head. They form terminals and are used to feed various types of fluids to/from the print head as will be explained in more detail in the following. Advantageously, the openings forming these terminals have diameters of at least 100 μm for easily contacting them to a macroscopic system of fluid sources and fluid drains.

The openings include advantageously the following:
At least one first opening is an ink feed terminal 26 for feeding ink to the print head.
At least one second opening is an ink withdrawal terminal 28 for retrieving ink from the print head. Together, the ink feed opening 26 and the ink withdrawal terminal 28 are used to establish an ink circulation in the print head.
At least one third opening is a humid gas feed terminal 30 for feeding humid gas to the nozzles.
At least one fourth opening is a dry gas feed terminal 32 for feeding dry gas to the blow openings 16.
At least one fifth opening is a gas withdrawal terminal 34 for retrieving gas from the suction openings 18.

The print head forms ducts between the terminals 26-34 at back side 12 and the nozzles and openings at front side 10.

### Print Head Layers

The print head is assembled from a plurality of layers, each of them extending horizontally. Their arrangement is best illustrated in FIGS. 1, 6, and 20.

The backmost layer of the shown print head, i.e. the layer S1 forming the terminal openings 26-34, is located behind a layer S2 forming horizontal bulk ducts 38-46. Advantageously, layers S1 and S2 are silicon layers.

In particular, layers S1 and S2 are formed from an SOI wafer, with S1 being the thinner silicon device layer and S2 being the thicker silicon handle layer of the SOI wafer. The insulator layer arranged between them (not shown in the figures) can be used as an etch stop during manufacturing of the structures in layers S1 and S2 and is finally etched off at least where the terminal openings 26-34 meet the bulk ducts 38-46. Alternatively, the structures may also be comprised of separate wafers that, for example, are adhesively bonded to each other.

Hence, advantageously, the print head comprises a first layer S1 forming the back side of the print head and a second layer S2 forming bulk ducts, with the bulk ducts extending horizontally and being connected to terminal openings in the first layer S1. Both layers S1, S2 are advantageously of silicon because silicon can easily be structured into deep, anisotropic trenches using Deep Reactive Ion Etching (DRIE).

In order to decrease the flow resistance of the bulk ducts 38-46, layer S2 advantageously has a thickness of at least 200 μm, in particular of at least 400 μm. A single bulk duct may be connected by several interface openings 26, 28, 30, 32, 34, in case the pressure loss from fluid flow across its length becomes too large. In such case, the distance between openings should be chosen such that the pressure drop across the bulk duct is minimized.

An interposer layer S3 is arranged on front of layer S2. It forms a plurality of vias connected to the bulk ducts 38-46.

Interposer layer S3 is advantageously of glass, and the vias therein may e.g. be formed using laser-induced etching, wherein in such case the etching process may be executed either before or after the glass wafer is bonded to layer S2.

Advantageously, interposer layer S3 is anodically bonded to layer S2, in which case the glass substrate of interposer layer S3 should be compatible with the anodic bonding process, e.g. Schott Mempax.

The thickness of interposer layer S3 should be small in order to reduce the flow resistance in its vias. In particular, layer S3 advantageously has thickness of less than 500 μm, in particular of 300 μm or less. If it is made of glass anodically bonded to layer S2, it should, for handling reasons, have a thickness of at least 100 μm.

Several distribution layers are arranged in front of layer S3. They form horizontal and vertical distribution ducts to be explained below, but they advantageously do not yet form parts of the front-facing structures of the individual nozzles. In the shown embodiment, there are three distribution layers A1, A2, A3 (with A1 being behind A2 and A2 being behind A3).

Several nozzle layers are arranged in front of the distribution layers A1-A3. The nozzle layers form the structures of the nozzles as well as further ducts for the various fluids. The figures show seven such layers. They are, in back-to-front-order, the layers M01, M02, M03, M04, M05, M07, and M08. Further layers, in particular the metal layers forming the electrodes, are not shown in most of the figures.

In this design, the distribution layers A1-A3 are substantially independent (in their thickness) of the nozzle design, i.e. their thicknesses can be optimized to meet the needs of the ducts they form.

The distribution layers A1, A2, A3 and nozzle layers M01-M08 are advantageously polymer layers as e.g. described in WO 2022/152379, section “Manufacturing”.

In particular, these layers may comprise honeycomb structures for reducing stress as described in WO 2022/152379 in the areas outside the ducts.

The thickness of the distribution layers can be chosen to reduce the flow resistance in the ducts. Hence, the layer(s) forming horizontal ducts (here, the layers A1 and A3), is/are thicker than the layer(s) forming vertical vias (here, the layer A2). For example, the layer(s) forming horizontal ducts (here, the layers A1 and A3) has/have a thickness between 10 and 100 μm while the layer(s) forming vertical vias (here, the layer A2) has/have a thickness between 5 and 15 μm.

In contrast to this, the thickness of most of the nozzle layers M01-M08 is given by the structures of the nozzles. For these layers, the thickness is typically in a range between 5 and 50 μm.

### Ink Feed and Withdrawal

The ink feed and withdrawal system of the present print head comprises ink feed ducts and ink withdrawal ducts. They are explained in the following.

Ink is fed from an ink source to the print head through at least one ink feed terminal 26, which is formed by an opening in layer S1, from where the ink enters a horizontal bulk ink feed duct 38 in layer S2 (cf. FIGS. 1, 4, and 6). Bulk ink feed duct 38 forms part of the ink feed ducts that connect ink feed terminal 26 to the nozzles 50.

There may be several ink feed terminals 26 forming parallel supply connections between the ink source and bulk ink feed duct 38 in order to reduce flow resistance.

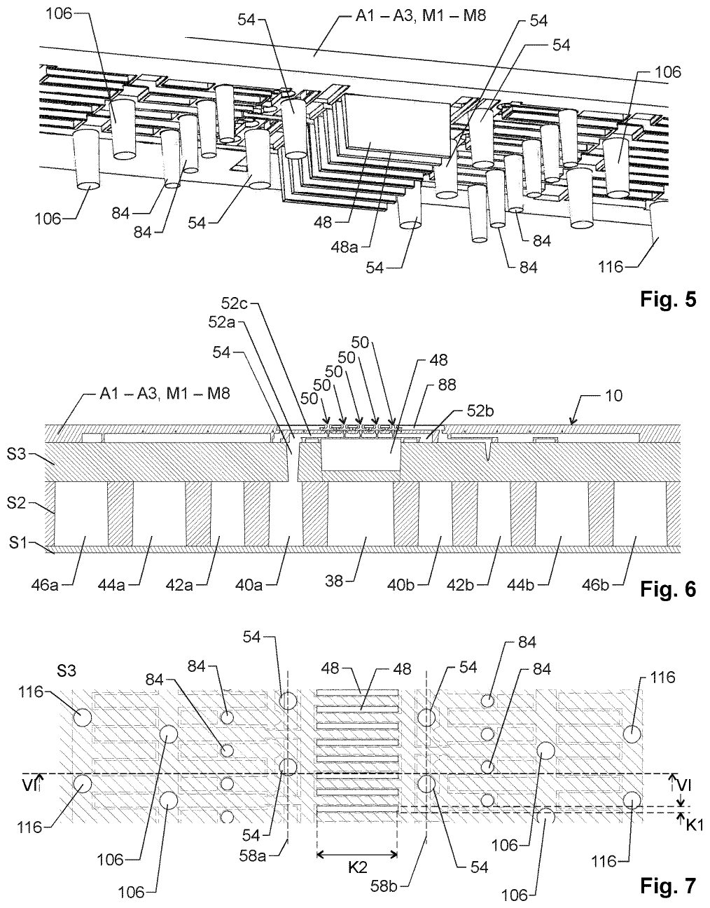

Bulk ink feed duct 38 communicates with several ink feed slit vias 48 in layer S3. As best seen in FIGS. 5-7, each ink feed slit 48 is a via having an elongate horizontal cross section with a width K1 much smaller than a length K2, in particular K1<K2/5.

The ink feed slit vias 48 extend parallel to the rows 50a of the nozzles 50, i.e. the longitudinal axis of the elongate horizontal cross section of each slit via extends parallel to the rows 50a. Advantageously, each ink feed slit via 48 is arranged vertically behind a row 50a of the nozzles 50.

Each ink feed slit via 48 is adapted to feed ink vertically through one or more layers of the print head to a row of several nozzles 50, advantageously to at least three nozzles, in particular to at least five nozzles. It has a backward end 48a connected to bulk ink feed duct 38 and a forward end 48b connected to the nozzles 50 in its row (cf. FIG. 20). It extends through layer S3 and, optionally, through one or more further layers above it. In the shown embodiment, it also extends through layer A1. The layers it crosses comprise slit-shaped openings at the location of the ink feed slit vias 48.

Using such ink feed slit vias 48 for vertically feeding ink to several nozzles arranged in a row allows to reduce the flow resistance of the ink and to maintain the same ink pressure at each nozzle 50 even when several of the nozzles are simultaneously ejecting ink.

As best seen in FIG. 6, bulk ink feed duct 38 is advantageously located vertically behind and centered on each feed slit via 48 for providing a homogeneous ink feed for the whole row of nozzles 50. (Note: in the sectional view of FIG. 6 the ink feed slit via 48 does not extend all the way through layer S3 because the sectional view of FIG. 6 is located slightly off-center of the tapered ink feed slit via 48, cf. line VI-VI of FIG. 7.)

The ink feed slit vias 48 are advantageously arranged parallel to each other, with one ink feed slit via 48 for each row 50a of nozzles 50, and they are connected to the same bulk ink feed duct 38. The bulk ink feed duct 38 extends parallel to the columns 50b of the nozzles.

In the present print head, ink is also retrieved from the print head to a print sink through at least one ink withdrawal terminal 28 in layer S1 (FIG. 3). The ink feed terminal(s) 26 are connected to the nozzles via ink feed ducts, and the nozzles 50 are connected to the ink withdrawal terminal(s) 28 via ink withdrawal ducts. As mentioned, this allows to maintain an ink circulation through the nozzles 50.

The ink withdrawal terminal(s) 28 is/are connected to at least one bulk ink withdrawal duct 40 in layer S2 (FIG. 4). Bulk ink withdrawal duct 40 forms part of the ink withdrawal ducts that connect the nozzles 50 to the ink withdrawal terminal 28. It has at least one section, advantageously two sections 40a, 40b, extending horizontally along a longitudinal edge 20a, 20c of active region 20 for homogeneously connecting the nozzles 50 in the rows 50a of ink nozzles.

Advantageously, the two sections 40a, 40b are interconnected by a third section 40c of the bulk ink withdrawal duct 40.

Bulk ink withdrawal duct 40 is arranged in the same layer(s), i.e. at the same height of the print head, as bulk ink feed duct 38 (in the layer S2 of the shown embodiment). Advantageously, ink feed duct 38 is arranged horizontally between the first and second section 40a, 40b of ink withdrawal duct 40.

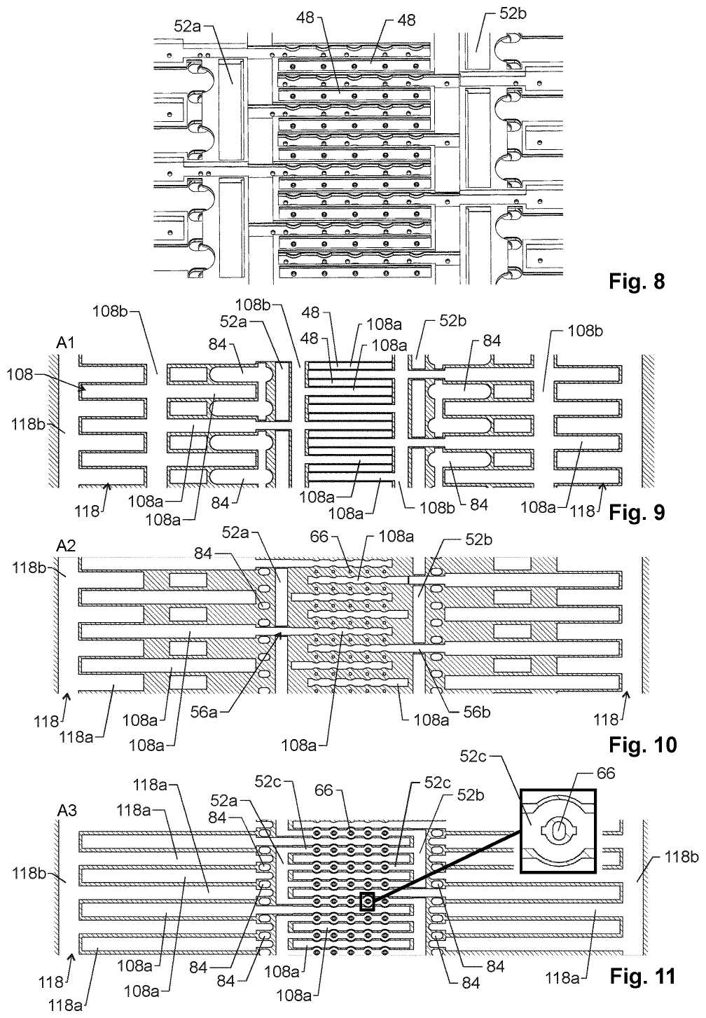

As shown in FIGS. 8-11, the ink withdrawal ducts further comprise an ink withdrawal manifold 52 comprising manifold sections 52a, 52b, 52c extending horizontally within the print head but at a level in front of bulk ink withdrawal duct 40:
First manifold sections 52a extend along first longitudinal edge 20a of active region 20, parallel and vertically above first section 40a of bulk ink withdrawal duct 40. The first manifold sections 52a are formed by openings in layers A1, A2, and A3 (see e.g. FIGS. 8-11).
Second manifold sections 52b extend along second longitudinal edge 20a of active region 20, parallel and vertically above second section 40b of bulk ink withdrawal duct 40. The second manifold sections 52b are again formed by openings in layers A1, A2, and A3.
Third manifold sections 52c extend parallel to the transversal edges 20b, 20d of active region 20 and are located vertically below the rows 50a of nozzles 50. The third manifold sections 52c are formed by openings in layer A3.

Ink withdrawal manifold 52 is connected to bulk ink withdrawal duct 40 by means of several withdrawal vias 54 extending through layer S3 (see FIGS. 5-7). By connecting ink withdrawal manifold 52 in a parallel manner to bulk ink withdrawal duct 40 by means of several withdrawal vias 54, a more homogeneous flow pattern in ink withdrawal manifold 52 can be achieved.

As follows from the above, the ink withdrawal manifold 52 advantageously comprises, in somewhat generalized terms:
At least a first manifold section 52a extending along first longitudinal edge 20a of active region 20: There may be one such first manifold section 52a extending along the whole length of the active region 20. Advantageously, however, and as shown in the figures, there are several such first sections 52a, with breaks 56a (one of them being shown in FIG. 10) between them because these breaks provide room for gas ducts as described below.
At least a second manifold section 52b extending along second longitudinal edge 20c of active region 20: Again, there may be one such second manifold section 52b extending along the whole length of the active region 20. Advantageously, however, and as shown in the figures, there are several such second sections 52b, with breaks 56b (one of them being shown in FIG. 10) between them because these breaks provide room for gas ducts as described below
Third manifold sections 52c extending parallel to transversal edges 20b 20d of active region 20. There is one such third manifold section 52c for each row of the nozzles 50 in order to withdraw ink from the nozzles in said row. Each third manifold section 52c is connect at least to one of the first and second manifold sections 52a, 52b for carrying off the ink.

Advantageously, at least some of the third manifold sections 52c are connected to both a first and a second manifold section 52a, 52b, thereby also interconnecting the first and second manifold sections 52a, 52b and providing a more homogenous flow distribution.

Advantageously, if (for the reasons outlined above) there are several first manifold sections 52a with breaks 56a between them and several second manifold sections 52b with breaks 56b between them, all the manifold sections are interconnected by means of the third manifold sections 52c for evenly distributing the flow of ink from the nozzles 50.

As can be seen from FIGS. 5-7, the withdrawal vias 54 extend through layer S3. Advantageously, and as shown in FIG. 7, the ink feed slits 48 are arranged between two rows 58a, 58b of the withdrawal vias 54.

### Nozzles

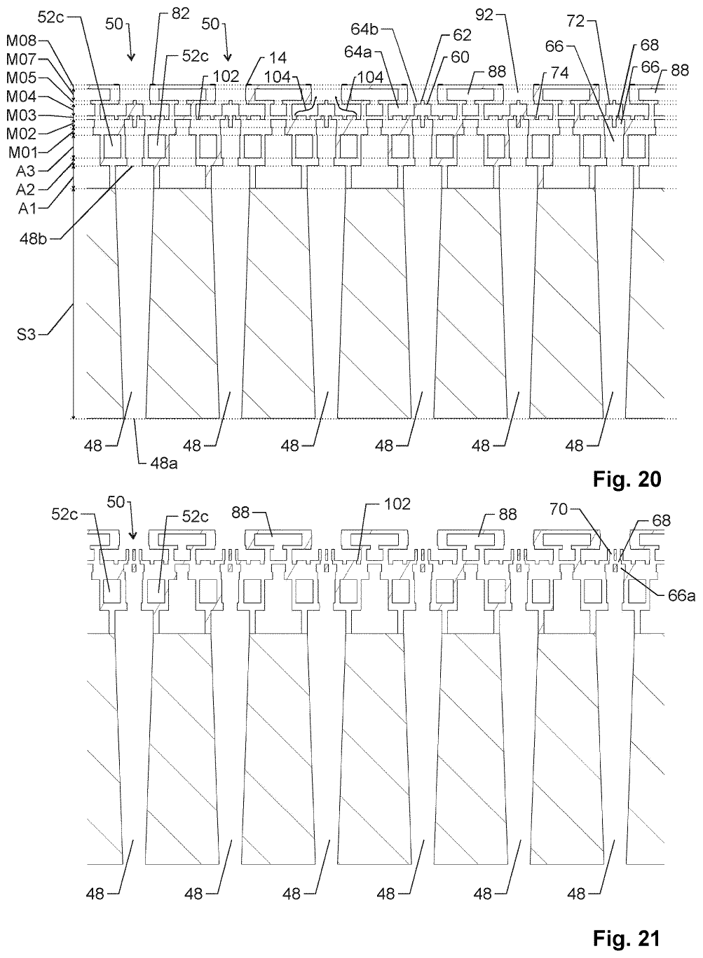

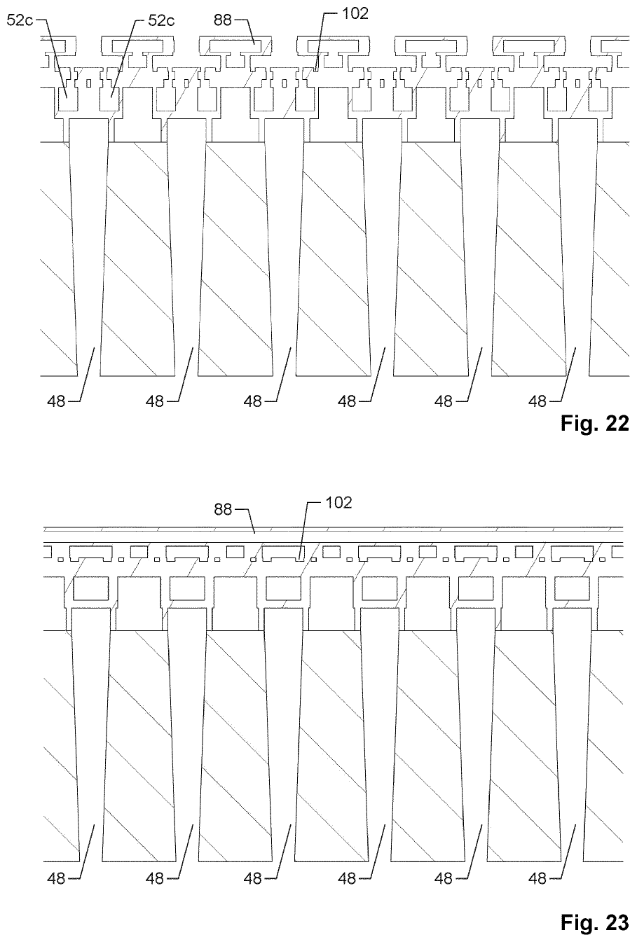

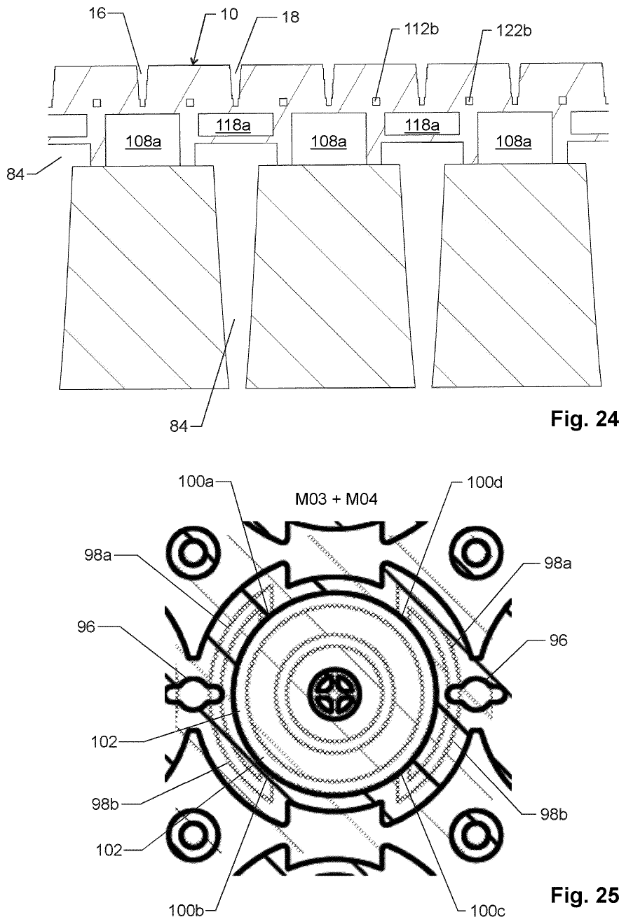

The nozzles are formed by the layers M01-M08, and their design is best described in reference to FIGS. 11-23.

Each nozzle 50 is arranged behind one of the nozzle openings 14. As shown in FIG. 20, it comprises a stub 60 (formed e.g. by the layers M04 and M05) with a central tip 62 (formed by layer M05) and is located in a nozzle chamber 64a, 64b. The chamber may have a lower, wider section 64a formed by layer M04 and an upper, narrower section 64b formed by layers M05, M07, and M08.

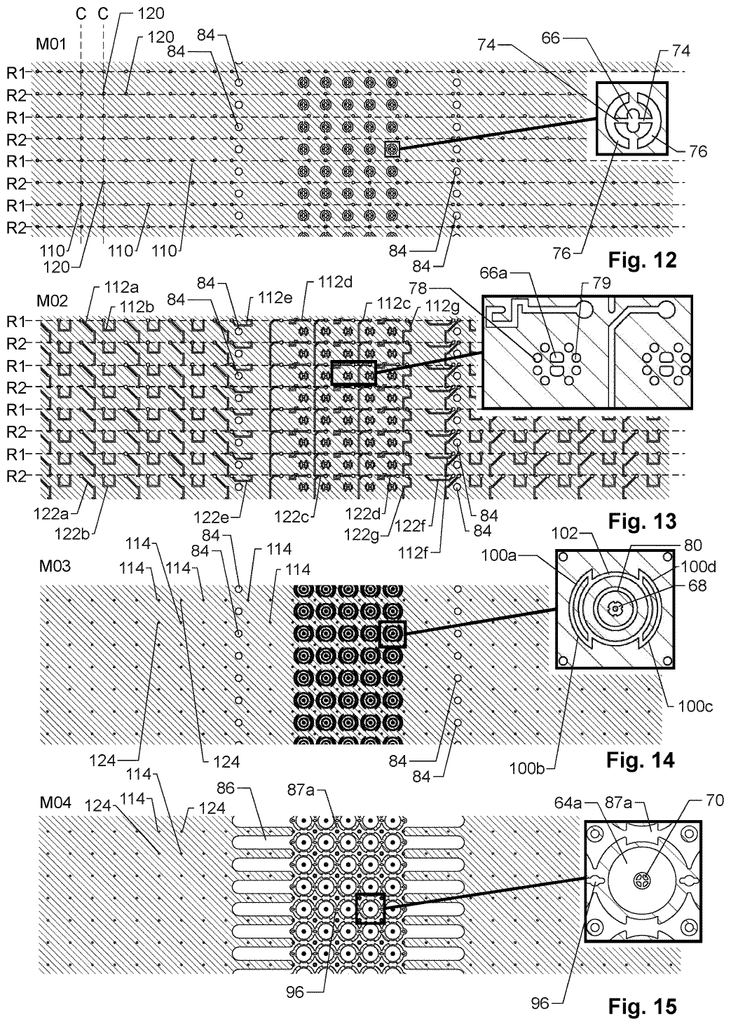

A nozzle ink feed via 66 is arranged beneath each nozzle 50 and is connected to one of the ink feed slits 48. In the present embodiment, it is formed by layers A2, A3, M01, and M02. As seen in FIGS. 12 and 13, nozzle ink feed via 66 branches out in FIGS. 12 and 13, into two central ducts 66a at layer M02.

The central ducts 66a are connected to a via 68 in layer M03, which in turn is connected to several vias 70 in layer M04 that carry the ink to the upper surface 72 of stub 60 surrounding tip 62.

Note: in FIG. 15, the vias 70 are shown to be laterally closed by the vertical side walls of stub 60. Alternatively, though, they can be open at that location, i.e. stub 60 may have a cross-shaped horizontal cross-section, with the ink flowing along the vertical recesses of stub 60. This design reduces the flow resistance while still maintaining a large volume of ink in the nozzle, ready to be dispensed when needed.

At layer M01, two interconnect ducts 74 branch off horizontally into two vias 76, which form part of the ink withdrawal ducts. The interconnect ducts 74 provide for a continuous ink flow through the nozzle. They are narrow to as compared to the ducts of the manifold structure in order to create a primary pressure drop at their position. Advantageously, for the third manifold sections 52c that move ink from multiple nozzles in lateral direction, it is important that the flow resistance of the third manifold sections 52c compared to the flow resistance of the interconnect ducts 74 is at least 10 times smaller, advantageously, at least 100 times smaller, in order to define the flow resistance almost solely by the interconnect ducts and thereby keep pressure-fluctuations along manifold sections 52c minimal. The flow resistance of a duct can be primarily reduced by reducing its cross-sectional area or by extending the length of the duct.

At their bottom side, the vias 76 are connected to third manifold section 52c, where the ink is carried off. At their top side, the vias 76 are connected to one or more further vias 79 in layer M02, which in turn communicate with an annular duct 80 in layer M03. Annular duct 80 is located at the bottom of nozzle chamber 64a, 64b and is used to carry off any overflowing ink at that location.

In FIG. 13, there are several vias 79 per nozzle. Alternatively, fewer vias, e.g. with an arcuate geometry, or a single via with an annular geometry, may be provided for each nozzle.

The operation of this type of system, where ink is recirculated through the nozzles, is described in WO 2022/152380. It can be used to continuously refresh the ink at the nozzles.

Each nozzle further comprises ejection electrodes 82 (only shown in FIG. 20), which can be controlled individually to eject ink drops from the nozzles. There may also be further electrodes for shaping the electrical field as described in WO 2022/152380.

Note that layer M02 may also be dispensed with and layer M01 may be directly connected to layer M03. In this case, the structures of M02 (e.g. 112a) can e.g. be arranged in layer M03.

### Humidification

As mentioned, the print head is advantageously adapted to feed humid gas to the nozzle openings to reduce the ink's tendency to form deposits at the nozzles.

The humid gas is fed through the humid gas feed terminal(s) 30 at the backside of the print head. From there it is led, by means of humid gas feed ducts, to the nozzles 50. The humid gas feed ducts are separate from the ink feed ducts, the ink withdrawal ducts, the dry gas feed ducts (to be discussed below), and the gas withdrawal ducts (to be discussed below).

The humid gas feed ducts comprise the bulk humid gas feed duct 42 (e.g. in layer S2, see FIG. 4), which directly communicates with the humid gas feed terminal(s) 30. Bulk humid gas feed duct 42 is arranged in the same layer(s), i.e. at the same height of the print head, as bulk ink feed duct 38 and bulk ink withdrawal duct 40.

As shown in FIG. 4, bulk humid gas feed duct 42 has at least one section, advantageously two sections 42a, 42b, extending horizontally along the longitudinal edge 20a, 20c of active region 20 for homogeneously connecting the nozzles 50 in the rows 50a of ink nozzles.

Advantageously, the two sections 42a, 42b are interconnected by a third section 42c of the bulk humid gas feed duct.

Advantageously, ink feed duct 38 is arranged horizontally between the first and second section 42a, 42b of bulk humid gas feed duct 40. More advantageously, and as shown in FIG. 4, also the first and second section 40a, 40b of bulk ink withdrawal duct 40 are arranged between the first and second section 42a, 42b of bulk humid gas feed duct 42.

The humid gas feed ducts further comprise a plurality of traversal humid gas feed lines 84 formed by vias and ducts extending through layer S3 (FIGS. 5 and 7), layer A1 (FIG. 9), layers A2 and A3 (FIGS. 10 and 11), and M1-M4 (FIGS. 12-15).

The traversal humid gas feed lines 84 communicate with horizontal humid gas feed lines 86 formed in layers M04, M05 and M07 (FIGS. 14, 16, 17).

The horizontal humid gas feed lines 86 are in turn connected to a horizontally extending humid gas feed manifold 88 in layer M07 (FIGS. 17, 20-23). At the level of layer M07, the connection of the horizontal humid gas feed lines 86 to humid gas feed manifold 88 is a direct one (i.e. not via other layers), as seen in FIG. 17. In addition, at the level of layer M04 (FIG. 15), the horizontal humid gas feed lines 86 are connected to an auxiliary cavity 87a in layer M04, which is vertically connected, by means of vias 87b extending through layer M05, to gas feed manifold 88 in layer M07. If necessary, the ducts may extend into further layers to increase their height and thereby to decrease their flow resistance.

Humid gas feed manifold 88 is connected to the bulk humid gas feed duct 42 by means of the humid gas feed lines 84 extending through the intervening layers. By connecting humid gas feed manifold 88 in a parallel manner to bulk humid gas feed duct 42 by means of several humid gas feed lines 84, a more homogeneous flow pattern in humid gas feed manifold 88 can be achieved.

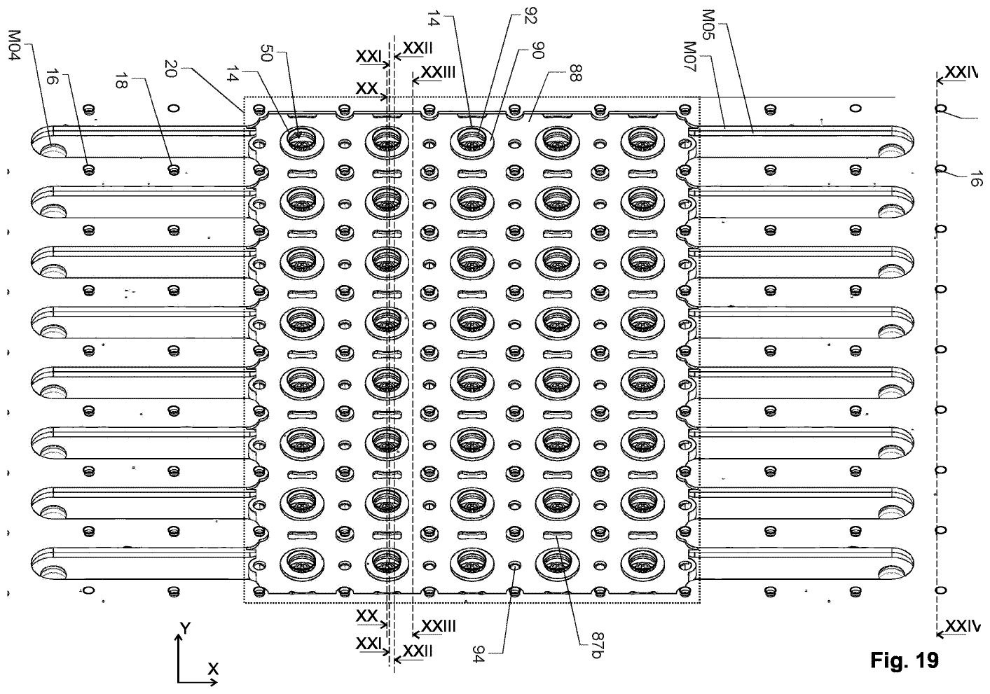

As can be seen in FIGS. 17 and 19, humid gas feed manifold 88 is arranged at a level of the print head located in front of the front most parts (the tips 62) of the nozzles 50 and continually extends over both horizontal directions (transversal direction X and longitudinal direction Y) of active area 20 of the print head. At each nozzle 50, layer M07 forms a closed-loop wall 90 separating humid gas feed manifold 88 from a passage 92, with passage 92 providing a path from nozzle 50 to nozzle opening 14.

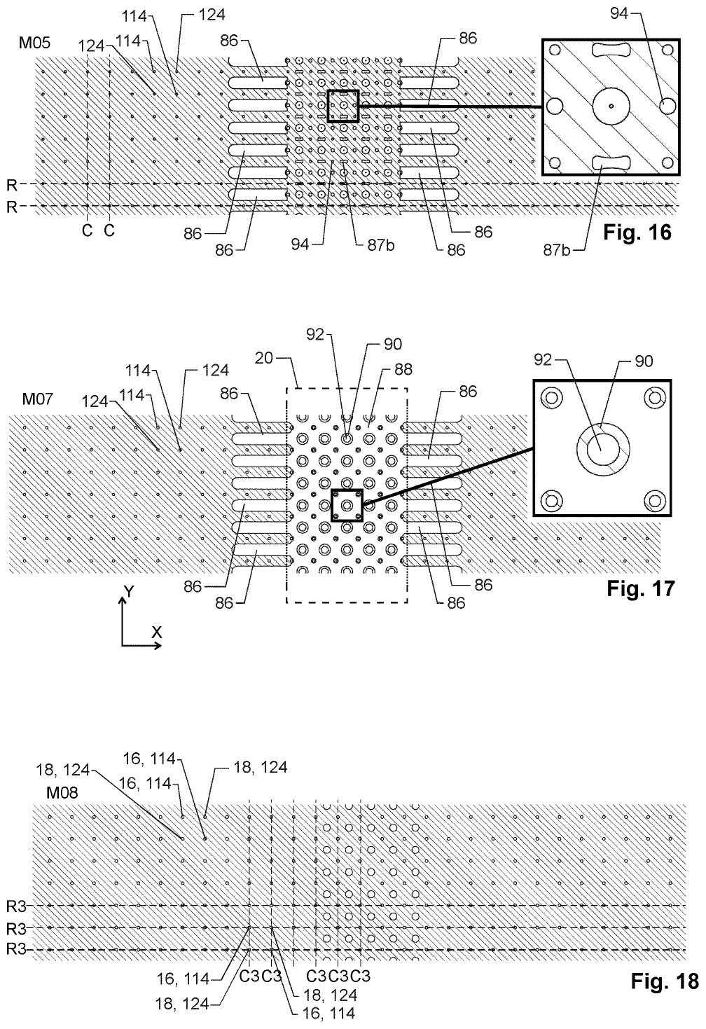

As can be seen in FIG. 16, layer M05, which forms the bottom wall of humid gas feed manifold 88, comprises vias 94 (FIGS. 16, 19), for each nozzle 50, which connect humid gas feed manifold 88 to vias 96 in layer M04 (FIG. 15).

From vias 96, the humid gas is led to nozzle chamber 64a, 64b. As shown in FIG. 25, which shows a superposition of layer M03 (hatched) and layer M04 (black), each via 96 in layer M04 communicates with two horizontal distribution ducts 98a, 98b in layer M03, which in turn lead the humid gas to four entry points 100a, 100b, 100c, 100d, which are distributed over the circumference of nozzle chamber 64a, 64b, and into an annular cavity 102 of layer M03, which forms an annular groove at the bottom of nozzle chamber 64a, 64b.

This design allows to generate an evenly distributed flow of humid gas in nozzle chamber 64a, 64b as illustrated by the arrows 104 in FIG. 20.

Hence, in more general terms, each nozzle 50 is arranged in a nozzle chamber 64a, 64b, wherein the humid gas feed ducts enter each nozzle chamber at at least three, in particular at at least four, entry points 100a-100d, which are distributed, advantageously evenly distributed, along the circumference of the nozzle chamber in order to provide a homogeneous gas flow.

Advantageously, the print head comprises, in a layer M03 adjacent below the nozzle chamber 64a, 64b, an annular opening 102 forming a groove at the bottom of nozzle chamber 64a, 64b, wherein the entry points 100a-100d are located in this annular opening.

### Dry Gas Feed

As mentioned, the print head is advantageously adapted to feed dry gas from the dry gas feed terminal(s) 32 at back side 12 of the print head to the blow openings 16 at front side 10 of the print head in order to expedite ink drying. Hence, the print head comprises dry gas feed ducts connecting the dry gas feed terminal(s) 32 to the blow openings 16.

Advantageously, for a compact design, the dry gas feed terminal(s) 32 are arranged in passive region 22 of the print head.

The dry gas feed ducts are separate from the ink feed ducts, the ink withdrawal ducts, the humid gas feed ducts and the gas withdrawal ducts (to be discussed below).

The dry gas feed ducts comprise the bulk dry gas feed duct 44, e.g. in layer S2 (FIG. 4), which directly communicates with the dry gas feed terminal(s) 32. Bulk dry gas feed duct 44 is arranged in the same layer(s), i.e. at the same height of the print head, as bulk ink feed duct 38 and/or bulk ink withdrawal duct 40 and/or the bulk humid gas feed duct 30.

Advantageously, for a compact design, bulk dry gas feed duct(s) 44 is/are arranged in the passive region 22 of the print head.

As shown in FIG. 4, bulk dry gas feed duct 44 has at least one section, advantageously two sections 44a, 44b, extending horizontally outside active region 20 and parallel to the longitudinal edge 20a, 20c of active region 20.

The two sections 44a, 44b may be interconnected by a third section of the bulk dry gas feed duct 44, similar as in the designs of bulk ink withdrawal duct 40 and bulk humid gas feed duct 42.

Advantageously, bulk ink feed duct 38 is arranged horizontally between the first and second section 44a, 44b of bulk dry gas feed duct 44. More advantageously, and as shown in FIG. 4, also the first and second section 40a, 40b of bulk ink withdrawal duct 40 as well as the first and second section 42a, 42b of bulk humid ink feed duct 42 are arranged between the first and second section 44a, 44b of bulk dry gas feed duct 44.

The dry gas feed ducts further comprise a plurality of traversal dry gas feed ducts 106 extending through layer S3 (FIGS. 5 and 7), which connect to a dry gas feed manifold 108 in layers A1-A3 (FIGS. 9-11) to bulk dry gas feed duct 44.

Dry gas feed manifold 108 comprises first ducts 108a extending horizontally and perpendicularly to the longitudinal edges 20a, 20c of active region 20 in order to carry the dry gas towards active region 20, but advantageously they also extend over at least 90% of the width (i.e. the extension parallel to the longitudinal edges 20a, 20c) of passive region 22 because the dry gas is also needed in the passive region.

In addition, dry gas feed manifold 108 comprises second ducts 108b interconnecting the first ducts 108a in layer A1.

Hence, the dry gas feed ducts comprise at least the following elements:
A bulk dry gas feed duct 44 having at least a first section 44a extending parallel to a first longitudinal edge 20a of the active region 20 and connected to the dry gas feed terminal(s) 30. Advantageously, bulk dry humid gas feed duct 44 comprises a first and a second section 44a, 44b arranged on opposite sides of active area 20.
A dry gas feed manifold 108, which extends horizontally at least around active region 20 to distribute the dry gas to the blow openings 16. This dry gas feed manifold 108 is located at a level in front of the bulk dry gas feed duct 44. The dry gas feed manifold 108 may comprise several sub-sections that lack horizontal connections between them, but advantageously all parts of dry gas feed manifold 108 are horizontally connected to each other.
Several traversal dry gas feed ducts 106 connecting, in parallel manner, bulk dry gas feed duct 44 to dry gas feed manifold 108.

In this way, a more homogeneous flow pattern in humid gas feed manifold 108 and therefore at the blow openings 16 can be achieved.
In layers A1-A3, the first ducts 108a extend into active region 20, with each first duct 108a extending parallel to and, when seen from above, between two rows 50a of the nozzles 50.

Dry gas feed manifold 108 is connected to first vias 110 in layer M01 (FIG. 12). The first vias 110 are arranged in first rows R1, with the first rows located vertically above the first ducts 108a of dry gas feed manifold 108.

As further can be seen e.g. from FIG. 12, the first vias 110 are arranged on first columns C. However, these columns are irregularly spaced, in particular at the interface between the passive and the active region.

The first vias 110 of layer M01 are connected to different types of first redistribution ducts 112a, 112b, 112c, 112d, 112e in layer M02 (FIG. 13). Each first redistribution duct 112a-112e extends between a first via 110 in layer M01 and a second via 114 in layers M03, M04, M05, M07, M08, which form the blow openings 16 at the front side of the print head.

The first redistribution ducts 112a-112e will be discussed in more details in the section “redistribution ducts” below.

### Gas Withdrawal

Further, and also as mentioned, the print head is advantageously adapted to withdraw gas from the suction openings 18 at the front side 10 of the print head through the gas withdrawal terminal(s) 34 at back side 12 of the print head. This allows to improve the gas exchange between the print head and the target and to avoid lateral gas flows that might deflect the ink. Hence, the print head comprises gas withdrawal ducts connecting suction openings 16 to the gas withdrawal terminal(s) 34.

Advantageously, for a compact design, the gas withdrawal terminal(s) 34 are arranged in passive region 22 of the print head.

The gas withdrawal ducts are separate from the ink feed ducts, the ink withdrawal ducts, the humid gas feed ducts and the humid gas feed ducts.

The gas withdrawal ducts comprise the bulk gas withdrawal duct 46, e.g. in layer S2 (FIG. 4), which directly communicates with the gas withdrawal terminal(s) 34. Bulk gas withdrawal duct 46 is arranged in the same layer(s), i.e. at the same height of the print head, as bulk ink feed duct 38 and/or bulk ink withdrawal duct 40 and/or the bulk humid gas feed duct 42, and/or the bulk dry gas feed duct 44.

Advantageously, for a compact design, bulk gas withdrawal duct(s) 46 is/are arranged in the passive region 22 of the print head.

As shown in FIG. 4, bulk gas withdrawal duct 46 has at least one section, advantageously two sections 46a, 46b, extending horizontally outside active region 20 and parallel to the longitudinal edge 20a, 20c of active region 20.

The two sections 46a, 46b may be interconnected by a third section of the bulk gas withdrawal duct 46, similar as in the designs of bulk ink withdrawal duct 40 and bulk humid gas feed duct 42.

Advantageously, bulk ink feed duct 38 is arranged horizontally between the first and second section 46a, 46b of bulk gas withdrawal duct 46. More advantageously, and as shown in FIG. 4, also the first and second section 40a, 40b of bulk ink withdrawal duct 40 as well as the first and second section 42a, 42b of bulk humid ink feed duct 42 are arranged between the first and second section 46a, 46b of bulk gas withdrawal duct 46.

The gas withdrawal ducts further comprise a plurality of traversal gas withdrawal ducts 116 extending through layer S3 (FIGS. 5 and 7), which connect to a gas withdrawal manifold 118 in layers A1-A3 (FIGS. 9-11).

Gas withdrawal manifold 118 comprises first ducts 118a extending horizontally and perpendicularly to the longitudinal edges 20a, 20c of active region 20 in order to carry the gas from active region 20, but advantageously they also extend over at least 90% of the width (i.e. the extension parallel to the longitudinal edges 20a, 20c) of passive region 22 because the gas also has to be withdrawn from the passive region.

In addition, gas withdrawal manifold 118 comprises second ducts 118b interconnecting the first ducts 118a in layers A1-A3.

Hence, the gas withdrawal ducts comprise at least the following elements:
A bulk gas withdrawal duct 46 having at least a first section 46a extending parallel to a first longitudinal edge 20a of the active region 20 and connected to the gas withdrawal terminal(s) 30. Advantageously, dry humid gas feed duct 46 comprises a first and a second section 46a, 46b arranged on opposite sides of active area 20.
A gas withdrawal manifold 118, which extends horizontally at least around active region 20 to collect the gas to the suction openings 18. This gas withdrawal manifold 118 is located at a level in front of the bulk gas withdrawal duct 46. The gas withdrawal manifold 118 may comprise several sub-sections that lack horizontal connections between them, but advantageously all parts of gas withdrawal manifold 118 are horizontally connected to each other.
Several traversal gas withdrawal ducts 116 connecting, in parallel manner, bulk gas withdrawal duct 46 to gas withdrawal manifold 118.

In this way, a more homogeneous flow pattern in humid gas withdrawal manifold 118 and therefore at the suction openings 18 can be achieved.

In layers A1-A3, the first ducts 118a extend into active region 20, with each first duct 118a extending parallel to and, when seen from above, between two rows 50a of the nozzles 50.

Gas withdrawal manifold 118 is connected to second vias 120 in layer M01 (FIG. 12). The second vias 120 are arranged in second rows R2, with the second rows located vertically above the first ducts 118a of gas withdrawal manifold 118.

As further can be seen e.g. from FIG. 12, the second vias 120 are arranged on the first columns C. However, and as mentioned above, these columns are irregularly spaced, in particular at the interface between the passive and the active region.

The second vias 120 of layer M01 are connected to different types of second redistribution ducts 122a, 122b, 122c, 122d, 122e in layer M02. Each second redistribution duct 122a-122e extends between a second via 120 in layer M01 and a second via 124 in layers M03, M04, M05, M07, M08, which form the suction openings 18 at the front side of the print head.

The second redistribution ducts 122a-122e will be discussed in more details in the section “redistribution ducts” below.

### Manifold Structure

The design of humid gas feed manifold 88 provides a very homogeneous distribution of the flow of a fluid over the active area. Even though it is illustrated here for being used to distribute the humid gas, it can also be used for distributing another gas, such as the dry gas being fed to the blow openings 16 or the gas returning from the suction openings 18.

Hence, in more general terms, the print head advantageously comprises a gas manifold structure arranged at a level of the print head located in front of the front most parts (the tips 62) of the nozzles 50 and continually extending at least over active area 20 of the print head. Further, at the level of the manifold and at each nozzle 50, a closed-loop wall 90 separates the manifold structure from a passage 92 providing a path from one nozzle 50 to a nozzle opening 14 at the front side 10 of the print head.

Advantageously, this manifold structure is adapted to feed humid gas to the nozzles and is connected to vias 94 that lead backwards to the nozzles as well as to other humid gas feed ducts that lead backwards to openings at the back side of the print head.

### Ducts Extending Forwards and Backwards in the Print Head

As it can already be derived from the last paragraph of the previous section, another important aspect of the humid gas feed duct design lies in the fact that, starting at the humid gas feed terminals 30, the humid gas feed ducts first traverse the print head into the forward direction (namely along traversal humid gas feed lines 84 as well as the vias 87b) to humid gas feed manifold 88 at a layer in front of the nozzles 50. From humid gas feed manifold 88, the humid gas feed ducts traverse the print head into the backward direction (namely long the vias 94, 96) before they lead the humid gas to the ink nozzle chambers 64a, 64b. Thus, the humid gas is first conveyed in a forward direction through the print head and then again in a backward direction before it is fed to the nozzle chamber 64a, 64b. This “detour” allows to use volume at the print head layers in front of the nozzles 50, e.g. for forming gas feed manifold 88 and/or other duct structures.

This type of duct design can also be applied to other gas duct structures in the print head, e.g. to the dry gas feed ducts and/or the gas withdrawal ducts.

Hence, in more general terms, the print head advantageously comprises gas ducts connecting openings (such as any of the openings terminals 26-34) in the back side 12 and openings the front side 10 (such as any of the openings 14-18) of the print head. These gas ducts comprise a first section (e.g. 84, 87b) extending into the forward direction and a second section (94, 96) extending into the backward direction of the print head, with the first and second sections arranged in series. (In this context, “extending” in a direction means that a path through the ducts from the openings at the backside to the openings at the front side heads into the forward direction of the print head.)

This scheme is particularly suited for the humid gas feed ducts, where the first section 84, 87b is located in the humid gas flow path between the at least one humid gas feed terminal 30 and manifold structure 88 and the second section 94, 96 is located in the humid gas flow path between manifold structure 88 and the nozzles 50. From the nozzles 50, the passages 92 extending through manifold structure 88 then may convey the humid gas to the nozzle openings 14.

### Redistribution Ducts

As mentioned, the dry gas feed ducts comprise first redistribution ducts 112a-112e and the gas withdrawal ducts comprise second redistribution ducts 122a-122e. In the shown embodiments, these redistribution ducts are arranged in layer M02 (FIG. 13) even though they might also be arranged in other layers, e.g. in layer M03, in particular if layer M02 is to be dispensed with.

Each redistribution duct extends horizontally and connects a via 110, 120 in the layer below it to a via 114, 124 in the layer above it. The vias are either vias of the dry gas feed ducts or of the gas withdrawal ducts.

In the layer below the redistribution ducts, the vias 110 of the dry gas feed ducts are arranged along the first rows R1, and the vias 120 of the gas withdrawal ducts are arranged along the second rows R2 such that the rows R1 and R2 of the dry gas feed ducts and the gas withdrawal ducts alternate. This allows to connect them to the straight first ducts 108a and 118a of the dry gas feed manifold 108 and the gas withdrawal manifold 118.

Further, and as shown in FIG. 12 for layer M01, the vias 110, 120 may be arranged on columns C. Along each column C, the vias 108 of the dry gas blow ducts and the vias 120 of the withdrawal ducts alternate. Advantageously, even though not necessarily, the columns C are perpendicular to the first and second rows R1, R2.

As mentioned above, the first columns C of the shown embodiment are irregularly spaced, in particular at the area between the passive and the active region, which provides more flexibility for placing the components in this region, e.g. the traversal humid gas feed lines 84.

At the front side of the print head, as illustrated in FIG. 18, the blow openings 16 and the suction openings 18 (and their corresponding vias 114, 124) are also arranged on rows R3 and on columns C3. The rows R3 extend parallel to the rows R1 and R2, with the distance between neighboring rows R3 being equal to half the distance between neighboring first rows R1 as well as being equal to half the distance between neighboring second rows R2.

However, along each row R3 and along each column C3 at the front side, the blow openings 16 and the suction openings 18 alternate, for the reasons described in WO 2021/008817. However, other geometries may be used as well, e.g. the other geometries described in WO 2021/008817. The redistribution ducts may be rearranged easily to accommodate for any pattern of the blow and suction openings.

The redistribution ducts 112a-112e and 122a-122e convert the duct geometries between row-wise separated dry gas feed ducts and withdrawal ducts (as shown in FIG. 12) and ducts that alternate along the rows as well as the columns (as shown in FIG. 18).

To achieve this, for example, for the dry gas feed ducts in passive region 22, a first type 112a of the first redistribution ducts alternates with a second type 112b of the first redistribution ducts (see FIG. 13). The first type 112a extends between two points on different rows R1, R2 while the second type 112b extends between two points on the same row R1. However, as shown, at least one of the two types extends along a non-straight path such that the two types have the same total length and therefore the same flow resistance. This ensures that the gas flow through all blow openings 16 in the passive region 22 is the same. This is ensured by designing the flow resistance inside the redistribution ducts much higher than the flow resistance inside first ducts 108a and 118a, by at least a factor 10, advantageously by at least a factor 100.

In more general terms, in any feed duct, the fluid, in particular the gas or ink, is advantageously first fed through first duct sections that are common to several blow openings (for the gas) or nozzles (for the ink or humid gas), and then through second duct sections that are individual for each blow opening or nozzle. In that case, the flow resistance inside the second duct section is advantageously higher by at least a factor 10 than the flow resistance inside the first duct sections.

Similarly, for the dry gas feed ducts in active region 20, a third type 112c of the first redistribution ducts alternates with a fourth type 112d of the first redistribution ducts. The third type 112a extends between two points on different rows R1, R2 while the fourth type 112d extends between two points on the same row R1. Again, at least one of the two types extends along a non-straight path such that the two types have the same total length and therefore the same flow resistance. This ensures that the gas flow through all blow openings 16 in the active region 20 is the same.

Further, advantageously, the length and flow resistance of all four types 112a, 112b, 112c, 112d are the same that the gas flow through all blow openings 16 in the active region 20 and the passive region is the same.

At least one fifth type 112e, 112f, 112g of redistribution duct is required, in the shown embodiment, at the edge of the active region in order to accommodate for the additional duct structures in this neighborhood, which are arranged horizontally along a second longitudinal edge 20c, e.g. second manifold section 52b. Therefore, vias 110 and 120 need to be dislocated out of the otherwise regular pattern of vias 110, 120, in order to not be formed above a section that carries ink, for example. Again, it has the same length as the other types.

As can be seen from FIG. 13, the second redistribution ducts similarly use five types 122a-122e to redistribute the withdrawal ducts, again with the same flow resistance in each of the five types.

Hence, advantageously, at a first height of the print head (e.g. in layer M01, FIG. 12) the dry gas feed ducts comprise vias (in the shown embodiment the vias 110 in layer M01) arranged on first rows R1 and, advantageously, on columns C, and the gas withdrawal ducts comprise vias (in the shown embodiment the vias 120 in layer M01) arranged on second rows R2 and, advantageously, on the columns C. The first and second rows R1, R2 are parallel and alternate. Along each first row R1, there are only vias of the dry gas feed ducts, and along each second row R2, there are only vias of the withdrawal ducts. Advantageously, on each column C, the dry gas feed ducts and the withdrawal ducts alternate.

At the front side 10 of the print head, the blow openings 16 and suction openings 18 are arranged on third row R3 and on third columns C3 (FIG. 18). Along reach row R, the blow openings 16 and the suction openings 18 alternate. Also, along each column C, the blow openings 16 and the suction openings 18 alternative.

At a second height (e.g. in layer M02, FIG. 12) between the “first height” and the front side 10 of the print head, the dry gas feed ducts comprise first redistribution ducts 112a-112g extending horizontally between the vias 110 coming from the first height and vias 114 leading to the front side 10. Similarly, the gas withdrawal ducts comprise second redistribution ducts 122a-122g extending horizontally between the vias 120 coming from the first height and vias 124 leading to the front side 10. All the first redistribution ducts have the same length and width, and all the second redistribution ducts have the same length and width.

Advantageously, the first redistribution ducts 112a-112g and/or the second redistribution ducts 122a-122g comprise a first type (e.g. 112a, 122a) and a second type (e.g. 112b, 122b) of redistribution ducts arranged alternatingly, with the first type connecting the vias from the first height to a different third row than the second type.

As shown in FIG. 18, and in contrast to the first columns C of FIG. 12, the third columns C3 are spaced regularly also in area between the passive and active areas.

The different types of redistribution ducts 122a-122g are used to convert the irregular spacing of the first columns C to the regular spacing of the third columns C3 by horizontally connecting between them, using different types of redistribution duct designs depending on the mutual offset between the first and third columns C, C3.

### Printing System and Print Head Operation

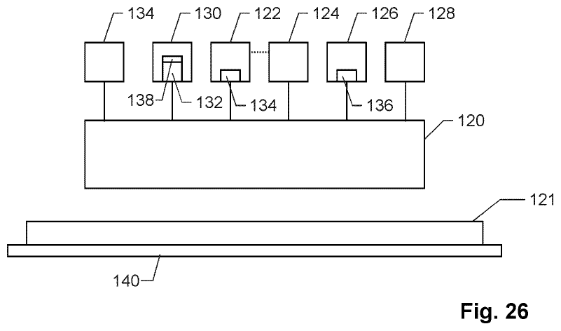

The print head forms part of a printing system that allows to operate the print head. The main components of such a printing system are illustrated in FIG. 26.

The shown system comprises the following components:
The print head 220, which is e.g. designed as described above. In operation, it is positioned to print ink onto a target 221.
An ink source 222 connected to the ink feed terminal(s) 26 of print head 220. It may e.g. comprise a pump or pressure source to force the ink into the print head.
An ink sink 224 connected to the ink withdrawal terminal(s) 28 of print head 220. It may comprise a pump or pressure sink to withdraw ink from the print head. Ink source 222 and ink sink 224 may form a closed circulation system as indicated by a dotted line.
A dry gas source 226 connected to the dry gas feed terminals 32 of print head 220. Again, it may comprise a pump or pressure source to force the dry gas into the print head.
A gas sink 228 connected to the gas withdrawal terminal(s) 34 of print head 220. Again, it may comprise a pump or pressure source to withdraw the dry gas from the print head.
A humid gas source 230 connected to the humid gas feed terminals 30 of print head 220. Again, it may comprise a pump or pressure source to force the dry gas into the print head. It also comprises an evaporator or bubbler 232 for dissolving a liquid in the gas to keep it humid. Evaporator or bubbler 232 may be external to print head 220 as shown, or it may be built into print head 220.
A control unit 234 controlling the operation of the print head. In particular, control unit 230 comprises signal generators for generating the control voltages for the nozzle electrodes.

The operation of the print head comprises feeding dry and humid gas to the print head by means of the dry and humid gas sources 226 and 230, feeding ink to the print head by means of ink source 222, retrieving ink from the print head by means of ink sink 224, and retrieving gas from the print head by means of gas sink 228.

Note that dry gas source 226 is adapted to feed a dryer gas to print head 220 than humid gas source 230 because the purpose of the humid gas is to prevent drying of the ink at the nozzles while the purpose of the dry gas is to expedite drying of the ink at the target. In contrast to humid gas source 230, dry gas source 226 typically does not have an evaporator 232.

The printing system may further comprise a temperature control to cool print head 220 and/or to heat target 221. This temperature control may include at least one of the following components, controlled by control unit 234:
An ink cooling unit 234 adapted to cool the ink from ink source 222. By feeding cooled ink to print head 220, the print head can be cooled.
A gas cooling unit 236 for cooling the gas from dry gas source 226 and or a gas cooling unit 238 for cooling the gas from humid gas source 230.
A target heater 240 for heating target 221.

Hence, in a particularly advantageous embodiment, the printing system comprises a gas cooling unit 236, 238 adapted and structured to cool the gas fed to the print head. This gas cooling unit may e.g. be a heat exchanger in thermal contact with the gas and being heated by a resistive heating.

### Notes

In the embodiment described above, ink is fed to the nozzles by means of the ink feed slit vias 58. Alternatively, smaller vias may be used. For example, FIG. 5 shows two rows of ink withdrawal vias 54, and one of these rows could instead be used to feed ink to the nozzles. Two separate manifolds with interdigitated feed and withdrawal ducts could be arranged in at least some of the layers A1-A3 for feeding the ink to the nozzles and withdrawing it therefrom.

In the described embodiments, the dry gas feed terminal(s) 32 as well as the gas retrieval terminal(s) 34 are arranged further away from the active region 20 than the humid gas feed terminal(s) 28. This allows for a more compact design because the humid gas is only required in the active region.

Note: Various structures in the print head are repetitive. Therefore, to keep the drawings simple, not all of the structures are provided with reference numbers. For example, FIGS. 5, 7, and 9-15 show the reference number 84 for only part of the vias and ducts of the traversal humid gas feed lines 84.

As becomes apparent from the above, the ink feed ducts and the ink withdrawal ducts are advantageously only connected to each other at the location of the nozzles. The dry gas feed ducts, the humid gas feed ducts, and the gas withdrawal ducts are advantageously not connected to each other.

While there are shown and described presently preferred embodiments of the invention, it is to be distinctly understood that the invention is not limited thereto but may be otherwise variously embodied and practiced within the scope of the following claims.

1. An electrohydrodynamic inkjet print head comprising:
a plurality of ink nozzles at a front side of the print head
a plurality of ventilation openings at the front side of the print head,
at least one ink feed terminal, and
ink feed ducts connecting the ink feed terminal to the nozzles,
wherein the front side has an active region surrounded by a passive region, wherein all the ink nozzles are arranged in the active region and wherein the ventilation openings are arranged in the active and the passive regions such that the active region is surrounded by ventilation openings.

2. The electrohydrodynamic print head of claim 1, wherein the ink nozzles are arranged in the active region in rows and columns.

3. The electrohydrodynamic print head of claim 2, wherein the active region is elongate having a short axis and a long axis, with the columns of the nozzles extending along the long axis and the rows of the nozzles extending along the short axis.

4. The electrohydrodynamic print head of claim 2, wherein the ink feed ducts comprise a plurality of ink feed slit vias and at least one horizontal bulk ink feed duct, with each ink feed slit via having a backward end connected to the bulk ink feed duct and a forward end connected to several nozzles arranged in a row, wherein the ink feed slit vias are arranged parallel to the rows of the ink nozzles.

5. The electrohydrodynamic print head of claim 4, wherein the bulk ink feed duct is located behind and centered on each feed slit via.

6. The electrohydrodynamic print head of claim 4,
wherein the ink feed slit vias are arranged parallel to each other, with one ink feed slit via for each row of nozzles,
wherein the ink feed slit vias are connected to the same bulk ink feed duct, and
wherein the bulk ink feed duct extends parallel to the columns of the nozzles.

7. The electrohydrodynamic print head of claim 4, wherein each ink feed slit via is adapted to feed ink along a vertical direction through at least one layer of the print head, wherein the layer or layers comprise slit-shaped openings at the location of the ink feed slit vias.

8. The electrohydrodynamic print head of claim 1, further comprising
at least one ink withdrawal terminal and
ink withdrawal ducts connecting the nozzles to the ink withdrawal terminal.

9. The electrohydrodynamic print head of claim 8, wherein the ink withdrawal ducts comprise a bulk ink withdrawal duct having at least a first section extending horizontally along a first longitudinal edge of the active region.

10. The electrohydrodynamic print head of claim 4, further comprising:
at least one ink withdrawal terminal; and
ink withdrawal ducts connecting the nozzles to the ink withdrawal terminal, wherein the ink withdrawal ducts comprise a bulk ink withdrawal duct having at least a first section extending horizontally along a first longitudinal edge of the active region,
wherein the bulk ink withdrawal duct is arranged at the same height as the bulk ink feed duct.

11. The electrohydrodynamic print head of claim 10, wherein the bulk ink withdrawal duct has a second section extending along a second longitudinal edge of the active region, wherein the bulk ink feed duct is horizontally arranged between the first and second sections of the bulk ink withdrawal duct.

12. The electrohydrodynamic print head of any of claim 9, wherein the ink withdrawal ducts comprise;
an ink withdrawal manifold extending horizontally and arranged at a level above the bulk ink withdrawal duct, and
a plurality of withdrawal vias extending in parallel between the ink withdrawal manifold and the bulk ink withdrawal duct.

13. The electrohydrodynamic print head of claim 12,
wherein the ink nozzles are arranged in the active region in rows- and columns, and
wherein the ink withdrawal manifold comprises:
at least a first manifold section extending horizontally along a first longitudinal edge of the active region,
at least a second manifold section extending horizontally along a second longitudinal edge of the active region, and
third manifold sections extending parallel to transversal edges of the active region, with one third manifold section for each row of the nozzles, wherein each third manifold section is connected to at least one of a first and a second manifold section.

14. The electrohydrodynamic print head of claim 13, wherein at least some of the third manifold sections are connected to both a first and a second manifold sections.

15. The electrohydrodynamic print head of claim 13, wherein the ink withdrawal manifold comprises several of the first manifold sections and several of the second manifold sections.

16. The electrohydrodynamic print head of claim 15,
wherein at least some of the third manifold sections are connected to both a first and a second manifold sections, and
wherein all the manifold sections are interconnected by the third manifold sections.

17. The electrohydrodynamic print head of claim 4, further comprising:
at least one ink withdrawal terminal; and
ink withdrawal ducts connecting the nozzles with the ink withdrawal terminal, wherein the ink withdrawal ducts comprise a bulk ink withdrawal duct having at least a first section extending horizontally along a first longitudinal edge of the active region,
wherein the ink withdrawal ducts comprise
an ink withdrawal manifold extending horizontally and being arranged at a level above the bulk ink withdrawal duct, and
a plurality of withdrawal vias extending in parallel between the ink withdrawal manifold and the bulk ink withdrawal duct, and
wherein the ink feed slits are arranged between two rows-of withdrawal vias.

18. The electrohydrodynamic print head of claim 1, further comprising
at least one humid gas feed terminal and
humid gas feed ducts connecting humid gas feed terminal to the nozzles.

19. The electrohydrodynamic print head of claim 18,
wherein each nozzle is arranged in a nozzle chamber and
wherein the humid gas feed ducts enter each nozzle chamber at at least three entry points, which are distributed along a circumference of the nozzle chamber.

20. The electrohydrodynamic print head of any of claim 18, wherein the humid gas feed ducts comprise a bulk humid gas feed duct having at least a first section extending horizontally along a first longitudinal edge of the active region.

21. The electrohydrodynamic print head of claim 4, further comprising:
at least one humid gas feed terminal; and
humid gas feed ducts connecting humid gas feed terminal to the nozzles, wherein the humid gas feed ducts comprise a bulk humid gas feed duct having at least a first section extending horizontally along a first longitudinal edge of the active region,
wherein the bulk humid gas feed duct is arranged at the same height as the bulk ink feed duct.

22. The electrohydrodynamic print head of claim 21, wherein the bulk humid gas feed duct has a second section extending along a second longitudinal edge of the active region, wherein the bulk ink feed duct is horizontally arranged between the first and second sections of the bulk humid gas feed duct.

23. The electrohydrodynamic print head of claim 20, further comprising:
at least one ink withdrawal terminal; and
ink withdrawal ducts connecting the nozzles to the ink withdrawal terminal, wherein the ink withdrawal ducts comprise a bulk ink withdrawal duct having at least a first section extending horizontally along a first longitudinal edge of the active region,
wherein the bulk humid gas feed duct is arranged at the same height as the bulk ink withdrawal duct.

24. The electrohydrodynamic print head of any of claim 20, wherein the humid gas feed ducts comprise:
a humid gas feed manifold extending horizontally and arranged at a level above the bulk humid gas feed duct, and
a plurality of humid gas feed lines extending in parallel between the bulk humid gas feed duct and the humid gas feed manifold.

25. The electrohydrodynamic print head of claim 1, further comprising a manifold structure arranged at a level of the print head located in front of most parts of the nozzles and extending over active area of the print head, wherein, at the level of the manifold structure and at each nozzle, a closed-loop wall separates the manifold structure from a passage providing a path from one nozzle to a nozzle opening at the front side of the print head.

26. The electrohydrodynamic print head of claim 24, further comprising a manifold structure arranged at a level of the print head located in front of most parts of the nozzles and extending over active area of the print head, wherein, at the level of the manifold structure and at each nozzle, a closed-loop wall separates the manifold structure from a passage providing a path from one nozzle-to a nozzle opening at the front side of the print head,
wherein the manifold structure forms the humid gas feed manifold.

27. The electrohydrodynamic print head of claim 1, further comprising gas ducts connecting openings in a back side of the print head and openings in the front side of the print head, wherein said gas ducts comprise a first section extending into a forward direction and a second section extending into a backward direction of the print head.

28. The electrohydrodynamic print head of claim 24, further comprising gas ducts connecting openings in a back side of the print head and openings in the front side of the print head, wherein said gas ducts comprise a first section extending into a forward direction and a second section extending into a backward direction of the print head,
wherein the first section is located in a humid gas flow path between the at least one humid gas feed terminal and the manifold structure and the second section is located in the humid gas flow path between the manifold structure and the nozzles.

29. The electrohydrodynamic print head of claim 1, further comprising:
at least one dry gas feed terminal, and
dry gas feed ducts connecting dry gas feed terminal to blow openings at the front side of the print head.

30. The electrohydrodynamic print head of claim 29, wherein the dry gas feed ducts comprise:
a bulk dry gas feed duct having at least a first section extending horizontally and parallel to a first longitudinal edge of the active region and connected to the dry gas feed terminal(s),
a dry gas feed manifold, which extends horizontally at least around the active region and located at a level in front of the bulk dry gas feed duct, and
several traversal dry gas feed ducts connecting, in parallel manner, the bulk dry gas feed duct to the dry gas feed manifold.

31. The electrohydrodynamic print head of claim 1, further comprising
at least one gas withdrawal terminal, and
gas withdrawal feed ducts connecting gas withdrawal terminal and suction openings at the front side of the print head.

32. The electrohydrodynamic print head of claim 31, wherein the gas withdrawal ducts comprise;
a bulk gas withdrawal duct having at least a first section extending horizontally and parallel to a first longitudinal edge of the active region and connected to the gas withdrawal terminal(s),
a gas withdrawal manifold, which extends horizontally at least around the active region and located at a level in front of the bulk gas withdrawal duct, and
several traversal gas withdrawal ducts connecting, in parallel manner, the bulk gas withdrawal duct to the gas withdrawal manifold.

33. The electrohydrodynamic print head of claim 30, further comprising:
at least one gas withdrawal terminal; and
gas withdrawal feed ducts connecting gas withdrawal terminal and suction openings at the front side of the print head,
wherein
at a first height of the print head, the dry gas feed ducts comprise vias arranged on first rows and the gas withdrawal ducts comprise vias arranged on second rows, with the first and second rows being parallel and alternating, wherein, along each first row, there are only vias of the dry gas feed ducts and along each second row, there are only vias of the gas withdrawal ducts,
at the front side, the blow openings and the suction openings 18 are arranged on third rows and third columns wherein, along each third row, the blow openings and the suction openings alternate and, also, wherein along each third column, the blow openings and the suction openings alternate, and
at a second height between the first height and the front side, the dry gas feed ducts comprise first redistribution ducts extending horizontally between vias coming from the first height and vias leading to the front side and the gas withdrawal ducts comprise second redistribution ducts extending horizontally between the vias coming from the first height and vias leading to the front side, wherein the first redistribution ducts have the same length, and all the second redistribution ducts have the same length.

34. The electrohydrodynamic print head of claim 33, wherein the first redistribution ducts and/or the second redistribution ducts comprise a first type and a second type of redistribution ducts arranged alternatingly, with the first type connecting the vias from the first height to a different third row than the second type.

35. The electrohydrodynamic print head of claim 33, wherein the vias of the gas feed ducts and the gas withdrawal ducts are arranged on irregularly spaced first columns while the third columns are regularly spaced, and wherein the redistribution ducts horizontally connect the first and third columns.

36. The electrohydrodynamic print head of claim 31, further comprising:
at least one humid gas feed terminal;
humid gas feed ducts connecting humid gas feed terminal to the nozzles;
at least one dry gas feed terminal; and
dry gas feed ducts connecting dry gas feed terminal with blow openings at the front side of the print head,
wherein the dry gas feed terminal(s) as well as the gas retrieval terminal(s) are arranged further away from the active region than the humid gas feed terminal(s).

37. The electrohydrodynamic print head of claim 1, comprising a first layer forming a back side of the print head and a second layer forming bulk ducts, wherein the bulk ducts extend horizontally and are connected to terminal openings in the first layer S1.

38. A printing system comprising the print head of claim 1, and an ink source connected to the at least one ink feed terminal, and further comprising at least one from the group of:
an ink sink connected to at least one ink withdrawal terminal of the print head,
a dry gas source connected to at least one dry gas feed terminal of the print head,
a gas sink connected to at least one gas withdrawal terminal of the print head, and
a humid gas source connected to at least one humid gas feed terminal of the print head.

39. The printing system of claim 38, further comprising a gas cooling unit to cool the gas fed to the print head.

40. The electrohydrodynamic print head of claim 4, wherein each ink feed slit via is arranged vertically behind a row of the nozzles.

41. The electrohydrodynamic print head of claim 11, wherein the first and second sections of the bulk ink withdrawal duct are interconnected by a third section of the bulk ink withdrawal duct.

42. The electrohydrodynamic print head of claim 25, wherein the manifold structure is connected to vias that lead backwards to the nozzles as well as to other gas feed ducts that lead backwards to openings at a back side of the print head.
